(19) United States
(12) Patent Application Publication
(10) Pub. No.: US 2004/0234734 A1
(43) Pub. Date: Nov. 25, 2004

(54) Apparatus and method for a shrink sleeve label for containers simulating a frosted or etched look and appearance

(76) Inventors: Donna Tran, Trevose, PA (US); Richard Thomas Keenan, Schaumburg, IL (US)

Correspondence Address: PETER F WEINBERG, GIBSON DUNN AND CRUTCHER LLP, SUITE 4100, 1801 CALIFORNIA STREET, DENVER, CO, 80202

(21) Appl. No.: 10/848,309

(22) Filed: May 18, 2004

Related U.S. Application Data
(60) Provisional application No. 60/471,890, filed on May 19, 2003.

(51) Int. Cl. B32B 31/00

(52) U.S. Cl. 428/195.1; 156/277; 264/509; 156/196

(57) ABSTRACT

A heat shrink sleeve label, when applied to a container, glass or plastic, replicates the look and feel of etched glass or frosted glass through a combination of an upper coating and a lower coating on a shrink film. The shrink film may be polyvinyl chloride, polyethylene terephthalate with or without glycol, or oriented poly styrene. Both water and solvent base frost inks are applied to the outer surface of the film. Frost inks contain a combination of pigments, waxes and solvents to achieve the frosted/acid etched look and feel. A tint coating is applied to the inner surface of the film. To prevent a “wet” look when the shrink sleeve label is not printed with a tint coating, an anti-wet coating is printed on the inner surface of the film to eliminate the spotty and/or water stain appearance when applied to a container that contains imperfections.

### CROSS REFERENCE TO RELATED APPLICATION

This application claims the benefit of U.S. Provisional Application No. 60/471,890, filed on May 19, 2003, titled “APPARATUS AND METHOD FOR A SHRINK SLEEVE LABEL FOR CONTAINERS SIMULATING A FROSTED GLASS OR ETCHED GLASS LOOK AND APPEARANCE”.

### FIELD OF THE INVENTION

This invention relates to shrink sleeve labels for containers, and more particularly, to a full body seamed shrink sleeve label that simulates the look and feel of etched glass or frosted glass traditionally achieved through acid etched technology.

### BACKGROUND OF THE INVENTION

To achieve a more pleasing aesthetic appearance, many glass or plastic bottles are given a frosted, opaque, or hazy appearance. Such an appearance has been used for beverage products such as wine, beer, and soft drinks, and for other products such as cosmetics, detergents, essential oils, chemicals, and the like. This appearance has been achieved in the past through various means, including a chemical etching process, which involves exposing the outer surface of the container to one or more strong acids, or by a mechanical abrading process. Both methods are time consuming and more expensive than the method and apparatus of the present invention, which has fewer steps and is relatively inexpensive.

### BRIEF DESCRIPTION OF THE DRAWINGS

FIG. 1 shows a schematic section view of an embodiment of the film for a shrink sleeve label of the present invention having an anti-wet undercoating.

FIG. 2 shows a schematic section view of an embodiment of the film for a shrink sleeve label of the present invention having a tint undercoating.

FIG. 3 shows a shrink sleeve label partially folded and prior to seaming in an embodiment of the present invention.

### DETAILED DESCRIPTION OF THE INVENTION

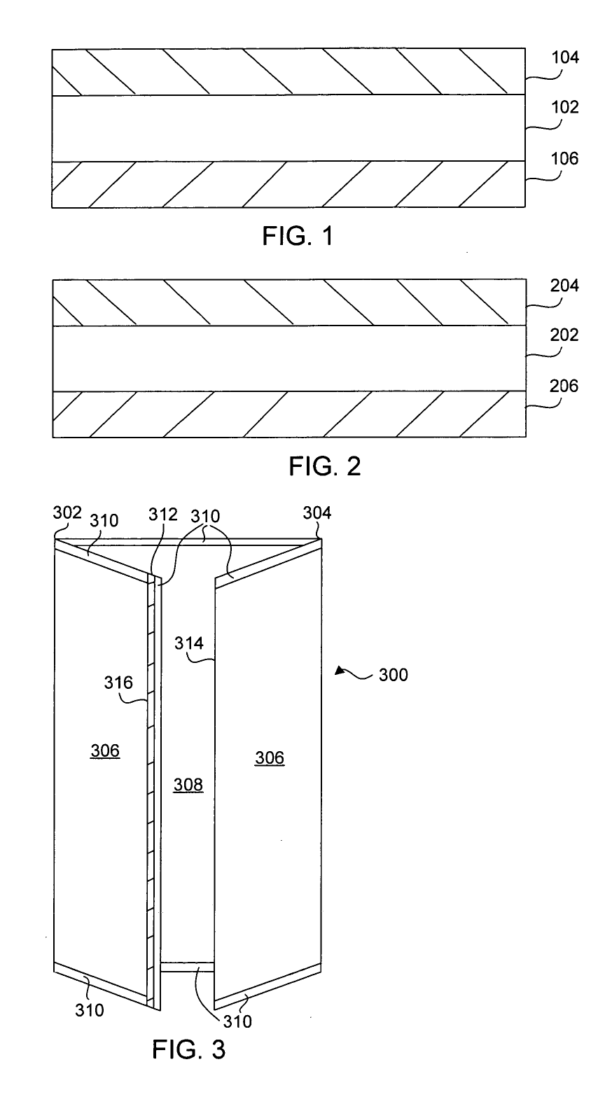

Referring now to the Figures, in which like reference numerals refer to like components thereof, FIG. 1 shows in section view a shrink sleeve label for a glass bottle of the present invention made from a Shrink Film 102 that is printed with a Frost Coating 104 on the outer surface of Shrink Film 102, and printed on an inner surface of Shrink Film 102 with an Anti-Wet Coating 106. In the embodiment of the invention shown in FIG. 1, to achieve the desired results of frosted/acid etched look and feel, the thickness for Shrink Film 102 was found to lie in the range between 1.0 to 3.0 mils. Likewise, the thickness for Frost Coating 104 was found to lie in the range between 0.1 to 0.6 mils. The thickness for Anti-Wet Coating 106 was found to lie in the range between 0.003 to 0.5 mils. In other embodiments of the invention for application with different containers, thickness outside these ranges may also be found to produce the desired results.

FIG. 2 shows in section view a shrink sleeve label for a glass bottle of the present invention made from a Shrink Film 202 that is printed with a Frost Coating 204 on the outer surface of Shrink Film 202, and printed on an inner surface of Shrink Film 202 with a Tint Coating 206, which provides a colored background. In the embodiment of the invention shown in FIG. 2, to achieve the desired results of frosted/acid etched look and feel, the thickness for Shrink Film 202 was found to lie in the range between 1.0 to 3.0 mils. Likewise, the thickness for Frost Coating 204 was found to lie in the range between 0.1 to 0.6 mils. The thickness for Tint Coating 206 was found to lie in the range between 0.003 to 0.5 mils. In other embodiments of the invention for application with different containers, thickness outside these ranges may also be found to produce the desired results.

Various types of shrink films may be printed with frost inks. Due to the differences in texture, clarity, adhesion and shrink performance of each film, some films are better than others in achieving the frosted/acid etched look and feel which is desired. In this embodiment of the invention, several different shrink films were found to have desirable qualities for Shrink Film 102 or Shrink Film 202. These include: polyvinyl chloride film (“PVC”) having a shrink range of between 35% to 70%, with a preferred range of between 40% to 65%; polyethylene terephthalate without glycol film (“PET”) or polyethylene terephthalate with glycol film (“PETG”), both having a shrink range of between 40% to 80%; and oriented polystyrene (“OPS”), having a shrink range of between 40% to 80%. Ultraviolet (“UV”) films, which are PVC, PET/PETG, or OPS films with a UV/Optical Brightener as an optional additive to their formulation, were identified as a specific application film that allowed for a blue tinted shrink appearance. A UV coating may also be applied to non-UV film during the printing process to achieve the blue tinted shrink appearance. In other embodiments of the invention, other types of film may be found that will produce the desired results.

In this embodiment of the invention, inks for printing on the shrink film were selected that visually and tactilely simulate the frosted/acid etched look and feel. The tactile feel of etched glass achieved by the inks is the result of the ink pigment sizes and concentrations. Inks were also selected based upon strong adhesion qualities.

To simulate the frosted/acid etched look the printed shrink sleeve label has diminished light reflection. The amount of frost ink lay down (amount of ink applied to the film) controls the light reflection, which dictates the engravings required to assure the proper lay down. To achieve the frosted/acid etched look, the reflectivity range of the frosted coating is measured as gloss, utilizing a Garner gloss meter at a sixty degree angle (60°). The Garner test method measures the percentage, out of 100%, of the light exposed that reflects back at the angle stated. Readings in the range between 8.0% to 12.0% were found to produce desirable results in this embodiment of the invention. Inks were also evaluated as to their resistance to scuffing from container to container contact during the sleeving and filling processes, as well as typical packaging and handling of a finished product. Inks were also selected that did not change color or appearance after shrinking by application of hot air, steam or radiant heat.

The characteristics of the inks desired in the present invention include visual appearance and tactile feel when printed on the shrink film, durability, color steadfastness, and strong adhesion quality. Both water and solvent base frost inks have been found suitable for application in the present invention. Frost inks containing a combination of pigments (with pigment size ranging between 2 to 32 microns), waxes and solvents have been found to achieve the frosted/acid etched look and feel. High shrink coatings are often utilized with the water base frost inks to improve drying and adhesion of the frost ink to the film. The following inks are representative of the inks that have been found to have the desired characteristics of tactile feel, light reflectivity, scuff resistance, color steadfastness, and adhesion qualities in combination with the films discussed above: Roto PVC Frost Over Print Varnish # AGC-7101 ink supplied by Merit Inks & Coating Co., Inc., Georgia; Aqua Frost Over Print Varnish # MWV28392 or MNV28531 Aqua Frost OPV ink supplied by Environmental Inks and Coatings, North Carolina; and Chieftain Frost Over Print Varnish and Liberty Frost Over Print Varnish supplied by the Coates Lorilleux Division (France) of Sun Chemical Corporation, New Jersey. Other inks may exist that are not yet known that may have similar or enhanced characteristics that may also achieve the desired results and may be substituted for one or more of the inks listed above. Depending upon the particular application for the shrink sleeve label of the present invention, one or more of the characteristics listed above may be of more significance than the others, which may determine which of the above inks would be selected for the particular application to produce the desired results.

To prevent a “wet” look when a shrink sleeve label is not printed with Tint Coating 206, Anti-Wet Coating 106 is used to eliminate a spotty or water stain appearance when the shrink sleeve label is applied to a container (glass, plastic, or other material) that contains imperfections (voids) on their surface. These imperfections can trap air between the shrink sleeve label and the container surface, giving rise to the spotty or water stain appearance. Anti-Wet Coating 106 creates breathable channels, allowing the air to escape during the shrinking phase, and thus eliminating the spotty or water stain appearance. Thus, the characteristic of the ink used for Anti-Wet Coating 106 is an ink that will create the breathable channels to allow air to escape during the shrinking phase. The following anti-wet ink is representative of the inks that have been found to have the desired characteristic that produces the desired results in combination with the films discussed above: Anti-Wet hr medium (cs) # UP-292-STR supplied by Hi Tech Color, Inc., Maryland. Other inks may exist that are not yet known that may have similar or enhanced characteristics that may also achieve the desired results and may be substituted for one or more of the anti-wet inks listed above. Depending upon the particular application for the shrink sleeve label of the present invention, one or more of the characteristics listed above may be of more significance than the others, which may determine which of the above inks would be selected for the particular application to produce the desired results.

Some label designs may have one or more areas that constitute a window devoid of any frost ink on the outer surface and devoid of any tint coating on the inner surface. The contents of the container may be viewed through the one or more windows of the film and through the container wall. In such cases, the inner surface of the window areas will have the anti-wet coating. The rest of the inner surface will have either the tint coating or further anti-wet coating. The artwork for a particular shrink sleeve label is dictated by the shape of the container and the amount of shrink required by that container shape.

Frost Coating 104/204 is printed on the outer surface of Shrink Film 102/202 (which faces away from the container) while the Anti-Wet Coating 106 and/or Tint Coating 206 is printed on the inner surface of Shrink Film 102/202 (which faces towards and contacts the container). Both Frost Coating 104/204 and Anti-Wet Coating 106/Tint Coating 206 are aligned in the machine direction, but are offset in the transverse direction to assure that an ink free area, called a “clear”, is present for the seaming operation. The seaming operation takes the flat printed roll of shrink film and converts it to a sleeve roll. Side to side registration is important, for which a maximum of ±0.25 millimeter tolerance is applied and maintained.

Many different printing processes may be used to print on the film, but gravure and flexography are preferred, utilizing continuous web substrate. Gravure is an intaglio process, in that the printing image is formed below the surface of the printing medium. A cylinder is engraved utilizing the art for the particular shrink sleeve label. The art for a particular shrink sleeve label is supplied for the engraving process most typically in an electronic format. The art is stepped and repeated to achieve the correct amount of images across and around the cylinder. The number of images across and around is dictated by the label width and label height. A shafted steel base of selected length is used as the base of the cylinder.

The cylinders are electronically engraved. The engraving process utilizes a diamond stylus and/or laser to engrave to the correct cylinder specifications, (line screens, angle and depth). Typical cylinder engraving specifications are as follows:

Frost Coating 104/204:

120 to 250 line screens (lines per inch)

90 to 130 degrees stylus (diamond)

36 to 50 micron depth (of the cells)

Anti-Wet Coating 106/Tint Coating 206:

120 to 250 line screens (lines per inch)

90 to 130 degrees stylus (diamond)

36 to 50 micron depth (of the cells)

Flexography is a relief printing process developed from the letterpress principle. The printing image is produced on a photopolymer plate, in which the image is physically above the non-image area. The photopolymer plate is imaged utilizing negative films, or direct-to-plate technology at a screen rule of 120 to 150 lines per inch. Typical plate gauge specifications are as follows:

Floor: 0.040 to 0.044 thousands of an inch

Relief: 0.023 to 0.027 thousands of an inch

Thickness: 0.066 to 0.068 thousands of an inch

Anilox rollers are utilized with a range of 200 to 900 lines per inch. Plates can be produced utilizing conventional film exposure methods, or digitally, with either wet or dry washout.

With either method of printing, one or more different inks of different color may be laid down to form the Frost Coating 104/204 or the Tint Coating 206 to achieve the desired label appearance. The Frost Coating 104/204 and the Anti-Wet Coating 106/Tint Coating 206 images are offset to produce the longitudinal clear areas for the seaming process. Thus, the artwork is laid out accordingly to prevent interference with the seam. The offset helps create a seamless appearance. Typically an ink adhesion test is performed at the start up of the printing operation and tested on each end of the roll press sample. Heat dryers and/or chill rollers are used after printing to assure adherence of the ink to the film.

The slitting operation takes the printed roll, with multiple images across the width of the film web, and slits them down the length of the film web to individual rolls for the seaming process. The right and left longitudinal clears needed for the seaming process are maintained by the slitter within a maximum of ±0.25 millimeter tolerance. Steel knives or blades are used for the slitting operation to assure a clean cut of the film. Each slit roll is identified with a roll tag and placed on a skid with protective cardboard to prevent damage to slit edges during transport. Once delivered, the rolls are then fed into a seaming machine.

Due to the film being printed on both the outer surface and inner surface, it is important that the web path through the particular seaming machine used is engineered to minimize and prevent abrasion or scratching of either top or bottom film surface.

FIG. 3 shows a shrink sleeve label partially folded and prior to seaming in an embodiment of the present invention. Referring now to FIG. 3, the seaming machine receives the loose end of the printed roll. The sides are folded inward to align the edges for seaming in order to form the sleeve. Only a first Panel 300 is shown for illustration purposes, it being understood that many additional panels follow behind on the roll.

A First Fold 302 and a Second Fold 304 are made to bring Edge 314 and Border 316 together for seaming. Outer Surfaces 306 have Frost Coating 104/204 and Inner Surface 308 has either Anti-Wet Coating 106 or Tint Coating 206, or in some cases, both. Longitudinal and transverse Clears 310 are devoid of any ink on either outer or inner surface. Seaming Agent 312 is laid down on top of longitudinal Clear 310 as shown. Edge 314 is aligned with Border 316 and pressed together to allow Seaming Agent 312 to adhere the two together, forming the continuous shrink sleeve label.

The fold quality of First Fold 302 and Second Fold 304 is important for two reasons. First, First and Second Folds 302/304 need to be very soft folds to prevent distortion of the ink. Second, hard folds do not shrink out properly, and may leave a white line on the container after shrinking. Most newer seaming equipment easily achieves the soft folds desired.

To assure soft folds in some older models of seaming equipment, proper taping of the forming plate and low wind of the seamed roll is of most importance. Special taping of the nip roller is performed to further assure soft folds and produce a solid Seaming Agent 312 down longitudinal Clear 310.

The folded and seamed continuous shrink sleeve label is wound, typically on ten inch cores at a very low tension with a minimum of fifteen millimeter oscillation, to additionally prevent damage to the folds. For handling purposes the roll is fastened with twist ties to prevent material from falling off of the core. In addition, custom cut pieces can be supplied for hand application. Typically though, rolls are shipped to the bottler. For shipping purposes, each roll and any cut pieces can be packed in a polly bag and placed inside a carton lined with foam for protection.

On the shrink sleeve application machine, the roll of continuous shrink sleeve labels are cut through the transverse Clears 310 to separate the continuous shrink sleeve labels on the roll one from the other, and are then positioned over the container. This is usually done in an automated process, but a manual process may also be used. The shrink sleeve labels are shrunk while over the container. The container at this time may either be empty or filled with the desired contents. Shrink methods include using hot air tunnels, radiant heat tunnels, steam heat tunnels, or combinations thereof, as is well known in the art. The shrink sleeve labeled containers can now be filled (if not already filled), packaged and shipped to their desired destinations.

Having described the present invention, it will be understood by those skilled in the art that many changes in construction and widely differing embodiments and applications of the invention will suggest themselves without departing from the scope of the present invention.

What is claimed is:

1. A method for simulating a frosted/acid etched look and feel to a container, the method comprising:
(a) printing an outer surface of a shrink film with at least one frost ink;
(b) printing an inner surface of a shrink film with at least one undercoat ink;
(c) seaming the shrink film to form a shrink sleeve;
(d). positioning said shrink sleeve over the container; and
(e) shrinking said shrink sleeve to the container, wherein said shrink sleeve shrunk to the container imparts to the container the frosted/acid etched look and feel.

2. A method according to claim 1 wherein said printing step (a) further comprises:
laying down said at least one frost ink on said shrink film in an amount necessary to achieve diminished light reflection gloss between 8.0% to 12.0% measured at a 60° angle.

3. A method according to claim 1 wherein said at least one undercoat ink is at least a one of an anti-wet coat ink and a tint coat ink.

4. A method according to claim 3 wherein said printing steps (a) and (b) further comprises:
creating at least one window area on said shrink film devoid of any of said at least one frost ink and devoid of any of said at least one tint coat ink.

5. A method according to claim 4 wherein said at least one window area has said at least one anti-wet coat ink printed on said inner surface of said shrink film.

6. A method according to claim 1 wherein said printing steps (a) and (b) further comprises:
printing said outer surface and said inner surface on a continuous shrink film, forming a plurality of label designs on said continuous shrink film.

7. A method according to claim 6 wherein said printing steps (a) and (b) further comprises:
creating a first longitudinal clear on a first edge of said continuous shrink film;
creating a second longitudinal clear on a second edge of said continuous shrink film; and
creating a plurality of transverse clears on said continuous shrink film;
wherein said first and second longitudinal clears and said plurality of transverse clears are devoid of any of said at least one frost ink and devoid of any of said at least one undercoat ink, and further wherein said transverse clears separate said plurality of label designs on said continuous shrink film one from another.

8. A method according to claim 7 wherein said seaming step (c) further comprises:
folding said first edge of said continuous shrink film inward;
folding said second edge of said continuous shrink film inward;
laying down a seaming agent on said first longitudinal clear on said first edge;
aligning said second longitudinal clear on said second edge with said first longitudinal clear on said first edge; and
pressing said first longitudinal clear and said second longitudinal clear together to form a continuous shrink sleeve label.

9. A method according to claim 8 further comprising the step of:
cutting said continuous shrink sleeve label along each of said plurality of transverse clears, separating said plurality of label designs one from another.

10. A method according to claim 1 wherein said shrinking step (e) further comprises:
passing said container with said shrink sleeve positioned thereon through at least a one of a hot air tunnel, a radiant heat tunnel, and a steam heat tunnel.

11. A shrink sleeve label for a container that imparts a frosted/acid etched look and feel to the container, the shrink sleeve label comprising:
a shrink film;
at least one frost ink printed on an outer surface of said shrink film;
at least one undercoat ink printed on an inner surface of said shrink film; and
a seam down a length of said shrink film;
wherein when the shrink sleeve label is positioned over the container and shrunk to the container, the shrink sleeve label imparts to the container the frosted/acid etched look and feel.

12. The shrink sleeve label according to claim 11 wherein said shrink film is a one of a polyvinyl chloride film, a polyethylene terephthalate without glycol film, a polyethylene terephthalate with glycol film, and an oriented polystyrene.

13. The shrink sleeve label according to claim 12 wherein said polyvinyl chloride film has a shrink range of between 35% to 70%, and said polyethylene terephthalate without glycol film, said polyethylene terephthalate with glycol film, and said oriented polystyrene have a shrink range of between 40% to 80%.

14. The shrink sleeve label according to claim 12 wherein said shrink film is an ultraviolet film with an ultraviolet/optical brightener additive.

15. The shrink sleeve label according to claim 12 wherein said polyvinyl chloride film has a preferred shrink range of between 40% to 65%.

16. The shrink sleeve label according to claim 11 wherein said shrink film has a thickness between 1.0 to 3.0 mils.

17. The shrink sleeve label according to claim 11 wherein said at least one frost ink printed on said outer surface of said shrink film is between 0.1 to 0.6 mils thick.

18. The shrink sleeve label according to claim 11 wherein said at least one undercoat ink printed on said inner surface of said shrink film is between 0.003 to 0.5 mils thick.

19. The shrink sleeve label according to claim 11 wherein said at least one undercoat ink is at least a one of an anti-wet coat ink and at least a one of a tint coat ink.

20. The shrink sleeve label according to claim 19 further comprising:
at least one window area on said shrink film devoid of any of said at least one frost ink and devoid of any of said at least one tint coat ink.

21. The shrink sleeve label according to claim 20 wherein said at least one window area has said at least one anti-wet coat ink printed on said inner surface of said shrink film.

22. The shrink sleeve label according to claim 11 wherein said at least one frost ink on said shrink film is laid down on said shrink film in an amount necessary to achieve diminished light reflection gloss between 8.0% to 12.0% measured at a 60° angle.

23. The shrink sleeve label according to claim 11 wherein said at least one frost ink further comprises pigment sizes ranging between 2 to 32 microns.

24. The shrink sleeve label according to claim 11 further comprising:
a first longitudinal clear on a first edge of said shrink film;
a second longitudinal clear on a second edge of said shrink film; and
a plurality of transverse clears on said shrink film;
wherein said first and second longitudinal clears and said plurality of transverse clears are devoid of any of said at least one frost ink and devoid of any of said at least one undercoat ink.

25. The shrink sleeve label according to claim 24 further comprising:
a seaming agent laid down on said first longitudinal clear on said first edge;
wherein said first longitudinal clear and said second longitudinal clear are pressed together to form said shrink sleeve label.

26. A shrink film for shrinking to a container that imparts a frosted/acid etched look and feel to the container, the shrink film comprising:
at least one frost ink printed on an outer surface of said shrink film; and
at least one undercoat ink printed on an inner surface of said shrink film;
wherein said at least one frost ink on said shrink film is laid down on said shrink film in an amount necessary to achieve diminished light reflection gloss between 8.0% to 12.0% measured at a 60° angle, imparting to the container the frosted/acid etched look and feel.

27. The shrink film according to claim 26 wherein said shrink film is a one of a polyvinyl chloride film, a polyethylene terephthalate without glycol film, a polyethylene terephthalate with glycol film, and an oriented polystyrene.

28. The shrink film according to claim 27 wherein said polyvinyl chloride film has a shrink range of between 35% to 70%, and said polyethylene terephthalate without glycol film, said polyethylene terephthalate with glycol film, and said oriented polystyrene have a shrink range of between 40% to 80%.

29. The shrink film according to claim 27 wherein said polyvinyl chloride film has a preferred shrink range of between 40% to 65%.

30. The shrink film according to claim 27 wherein said shrink film is an ultraviolet film with an ultraviolet/optical brightener additive.

31. The shrink film according to claim 26 wherein said shrink film has a thickness between 1.0 to 3.0 mils.

32. The shrink film according to claim 26 wherein said at least one frost ink printed on said outer surface of said shrink film is between 0.1 to 0.6 mils thick.

33. The shrink film according to claim 26 wherein said at least one undercoat ink printed on said inner surface of said shrink film is between 0.003 to 0.5 mils thick.

34. The shrink film according to claim 26 wherein said at least one undercoat ink is at least a one of an anti-wet coat ink and at least a one of a tint coat ink.

35. The shrink film according to claim 34 further comprising:
at least one window area on said shrink film devoid of any of said at least one frost ink and devoid of any of said at least one tint coat ink.

36. The shrink film according to claim 35 wherein said at least one window area has said at least one anti-wet coat ink printed on said inner surface of said shrink film.

37. The shrink film according to claim 26 wherein said at least one frost ink further comprises pigment sizes ranging between 2 to 32 microns.

38. The shrink film according to claim 26 further comprising:
a first longitudinal clear on a first edge of said shrink film; and
a second longitudinal clear on a second edge of said shrink film;
wherein said first and second longitudinal clears are devoid of any of said at least one frost ink and devoid of any of said at least one undercoat ink.

39. The shrink film according to claim 38 further comprising:
a seaming agent laid down on said first longitudinal clear on said first edge;
wherein said first longitudinal clear and said second longitudinal clear are pressed together to form a shrink sleeve label.

40. A container have a shrink sleeve label applied thereon, comprising:
at least one frost ink printed on an outer surface of said shrink sleeve label; and
at least one undercoat ink printed on an inner surface of said shrink sleeve label;
wherein the shrink sleeve label is positioned over the container and shrunk to the container, imparting to the container the frosted/acid etched look and feel.

41. The shrink film according to claim 40 wherein said shrink film is a one of a polyvinyl chloride film, a polyethylene terephthalate without glycol film, a polyethylene terephthalate with glycol film, and an oriented polystyrene.

42. The shrink film according to claim 41 wherein said polyvinyl chloride film has a shrink range of between 35% to 70%, and said polyethylene terephthalate without glycol film, said polyethylene terephthalate with glycol film, and said oriented polystyrene have a shrink range of between 40% to 80%.

43. The shrink film according to claim 41 wherein said polyvinyl chloride film has a preferred shrink range of between 40% to 65%.

44. The shrink film according to claim 41 wherein said shrink film is an ultraviolet film with an ultraviolet/optical brightener additive.

45. The shrink film according to claim 40 wherein said shrink film has a thickness between 1.0 to 3.0 mils.

46. The shrink film according to claim 40 wherein said at least one frost ink printed on said outer surface of said shrink film is between 0.1 to 0.6 mils thick.

47. The shrink film according to claim 40 wherein said at least one undercoat ink printed on said inner surface of said shrink film is between 0.003 to 0.5 mils thick.

48. The shrink film according to claim 40 wherein said at least one undercoat ink is at least a one of an anti-wet coat ink and at least a one of a tint coat ink.

49. The shrink film according to claim 48 further comprising:
at least one window area on said shrink film devoid of any of said at least one frost ink and devoid of any of said at least one tint coat ink.

50. The shrink film according to claim 49 wherein said at least one window area has said at least one anti-wet coat ink printed on said inner surface of said shrink film.

51. The shrink film according to claim 40 wherein said at least one frost ink further comprises pigment sizes ranging between 2 to 32 microns.

52. The shrink film according to claim 40 further comprising:
a first longitudinal clear on a first edge of said shrink film; and
a second longitudinal clear on a second edge of said shrink film;
wherein said first and second longitudinal clears are devoid of any of said at least one frost ink and devoid of any of said at least one undercoat ink.

53. The shrink film according to claim 52 further comprising:
a seaming agent laid down on said first longitudinal clear on said first edge;
wherein said first longitudinal clear and said second longitudinal clear are pressed together to form the shrink sleeve label.

54. The shrink sleeve label according to claim 40 wherein said at least one frost ink on said shrink film is laid down on said shrink film in an amount necessary to achieve diminished light reflection gloss between 8.0% to 12.0% measured at a 60° angle.

55. The shrink sleeve label according to claim 40 wherein said container is a one of a glass container and a plastic container.
